(19) United States
(12) Patent Application Publication
(10) Pub. No.: US 2015/0254622 A1
(43) Pub. Date: Sep. 10, 2015

(54) PAYMENT TERMINAL APPARATUS

(71) Applicant: PANASONIC INTELLECTUAL PROPERTY MANAGEMENT CO., LTD., Osaka (JP)

(72) Inventor: Manabu MATSUMOTO, Osaka (JP)

(73) Assignee: PANASONIC INTELLECTUAL PROPERTY MANAGEMENT CO., LTD., Osaka (JP)

(21) Appl. No.: 14/638,070

(22) Filed: Mar. 4, 2015

(30) Foreign Application Priority Data
Mar. 10, 2014 (JP) 2014-046918

(51) Int. Cl. G06Q 20/20; G06Q 20/40

(52) U.S. Cl. CPC G06Q 20/20; G06Q 20/4014

(57) ABSTRACT

An operating system sets a secured flag to “True”, and changes to a secured mode. An operation to light an LED display is performed, and letters “SECURED” are displayed. A screen UI application displays a message for encouraging a user to input PIN and a PIN pad on a touch panel. A touch panel input/output execution control unit inputs the PIN on the touch panel through a touch panel driver. When the PIN is input, the operating system sets the secured flag to “False”, and changes to a non-secured mode. An operation to extinguish the LED display is performed. When a non-secured part is included, it is possible to ensure tamper resistance for securing information security, and it is possible to safely perform a certification process, a payment process, or the like with fewer mistakes of a user.

### BACKGROUND OF THE INVENTION

1. Field of the Invention

The present disclosure relates to a payment terminal apparatus which is used to perform the procedure of a payment process for a transaction.

2. Description of the Related Art

For example, in the (credit) transaction of products or services using a credit card, the safety (security) of the transaction is ensured by checking (performing identification) whether a person who performs the transaction is identical to the owner of the credit card which is used for the transaction. The identification is performed in such a way that a customer puts a signature on a transaction slip, on which transaction content is printed, when a payment process for the transaction is performed, and a clerk compares the signature and a signature which is written on the credit card by sight.

In recent years, terminal apparatuses which are capable of inputting and displaying such a signature are realized using smart phones or tablet terminals. A plurality of smart phones or tablet terminals are distributed as consumer devices, and it is possible to construct payment terminal apparatuses by supplying the payment terminal apparatuses inexpensively. That is, the payment terminal apparatuses may be supplied inexpensively if the payment terminal apparatuses are constructed using information terminals which are distributed a lot as the consumer devices such as the smart phones or the tablet terminals. In addition, since it is possible to generalize application (software) development platforms which are used for other business in addition to the payment process, it is easy to reuse or divert development assets.

However, an information terminal, which is designed based on an assumption that the information terminal is used as a consumer device, is not furnished with “tamper resistance” which is necessary to ensure customer information and to safely perform a transaction. The “tamper resistance” is resistance against an attack which is an attempt to steal information from the information terminal. For example, as disclosed in a specification of U.S. Patent Unexamined Publication No. 2010/0145854, in order to ensure the tamper resistance as a measure against the attack which is an attempt to steal information from the information terminal, a moving body apparatus is proposed in which a part (secured unit, that is, a part having tamper resistance which is necessary as the payment terminal apparatus) relevant to the certification information of a card used for the payment process is separated from a general-purpose part.

In addition, in the case of a general-purpose terminal apparatus, it is necessary to ensure information security when, in particular, a Personal Identification Number (PIN), such as password, is input. For example, as disclosed in the specification of U.S. Pat. No. 8,376,219, in order to ensure such tamper resistance, a banking system, which includes a PIN pad for encrypting PIN input by a user in a payment process, is known. In addition, for example, as disclosed in Japanese Patent Unexamined Publication No. 2006-185449, a touch screen apparatus is known which encrypts information input on a touch screen and transmits the encrypted information. However, in the above-described information processing apparatus according to related art, there is a possibility that security is ensured for a secured part but security is insufficient for a non-secured part. For example, when an unauthorized application is installed in the non-secured part, there is a possibility that a regular input area, to which certification information (for example, PIN or signature) for identity verification is input, is illegally hidden. In addition, there is a possibility that an additional unauthorized input area is displayed due to the unauthorized application. Further, there is a possibility that a user makes a mistake in assuming that the unauthorized input area is regular, with the result that, the user inputs the certification information to the unauthorized input area, and thus the certification information is stolen (fished).

### SUMMARY OF THE INVENTION

A payment terminal apparatus according to the present disclosure has a configuration in which it is possible to safely perform a certification process, a payment process, and the like with fewer mistakes by user after ensuring tamper resistance for securing information security even when a non-secured part is included.

According to the present disclosure, there is provided a payment terminal apparatus including: an information processing unit that includes a display unit which is accommodated in a housing and is configured to display price or the like relevant to payment in a first non-secured execution environment, and an input unit to which certification information for identity verification is input in a second secured execution environment; a notification unit that provides notification about a secured mode state; and a notification control unit that is provided in the second secured execution environment and is configured to control the notification unit. The notification control unit does not provide the notification about the secured mode state to the notification unit when a payment process starts, and subsequently provides the notification about the secured mode state to the notification unit until at least the certification information is input to the input unit.

In the payment terminal apparatus according to the present disclosure: price or the like relevant to payment is displayed on the display unit in the first non-secured execution environment, certification information for identity verification is input to the input unit in the second secured execution environment, and notification about a secured mode state is provided. The notification control unit that is configured to control the operation of the notification unit is provided in the second secured execution environment. The notification control unit does not provide the notification about the secured mode state to the notification unit when the payment process starts, and subsequently provides the notification about the secured mode state to the notification unit until at least the certification information is input to the input unit. Therefore, the payment terminal apparatus is capable of controlling an operation to provide notification about the secured mode state or the non-secured mode state in the secured execution environment. When the non-secured execution environment is provided, it is possible to safely perform a certification process, a payment process, or the like with fewer mistakes by a user after ensuring tamper resistance for securing information security.

### BRIEF DESCRIPTION OF DRAWINGS

FIG. 1A is a front view illustrating the appearance of a payment terminal apparatus according to a first embodiment;

FIG. 1B is a side view illustrating the appearance of the payment terminal apparatus shown in FIG. 1A;

FIG. 2 is a block diagram illustrating an example of the hardware configuration of the payment terminal apparatus according to the first embodiment in detail;

FIG. 3 is a block diagram illustrating an example of a system configuration based on the software function of the payment terminal apparatus according to the first embodiment in detail;

FIG. 4 is a flowchart illustrating the procedure of a first operation performed when the payment terminal apparatus according to the first embodiment performs a payment process;

FIG. 5 is a flowchart illustrating the procedure of a second operation performed when the payment terminal apparatus according to the first embodiment performs the payment process;

FIG. 6 is a flowchart illustrating the procedure of an operation to light or extinguish an LED display;

FIG. 7 is a front view illustrating the appearance of the payment terminal apparatus in a secured mode;

FIG. 8 is a front view illustrating the appearance of a payment terminal apparatus in a secured mode according to a modification example of the first embodiment;

FIG. 9 is a front view illustrating the appearance of the payment terminal apparatus in a non-secured mode;

FIG. 10 is a front view illustrating the appearance of a payment terminal apparatus according to a second embodiment;

FIG. 11 is a flowchart illustrating the procedure of a first operation when the payment terminal apparatus according to the second embodiment performs a payment process;

FIG. 12 is a flowchart illustrating the procedure of a second operation when the payment terminal apparatus according to the second embodiment performs the payment process;

FIG. 13 is a flowchart illustrating the procedure of an operation to light or extinguish an LED display;

FIG. 14 is a front view illustrating the appearance of the payment terminal apparatus in a secured mode;

FIG. 15 is a front view illustrating the appearance of a payment terminal apparatus in a non-secured mode according to a modification example of the second embodiment; and

FIG. 16 is a front view illustrating the appearance of the payment terminal apparatus in the secured mode.

### DETAILED DESCRIPTION OF THE PREFERRED EMBODIMENTS

Hereinafter, embodiments of the present disclosure will be described with reference to the accompanying drawings. In the embodiments below, a payment terminal apparatus, which is used for a payment process in the transaction of products or services, will be described as an example of a payment terminal apparatus according to the present disclosure. Meanwhile, the present disclosure may be realized as a computer-readable recording medium which causes an information processing apparatus to execute an operation of a payment processing method or a program which causes the information processing apparatus to execute the operation of the payment processing method.

### First Embodiment

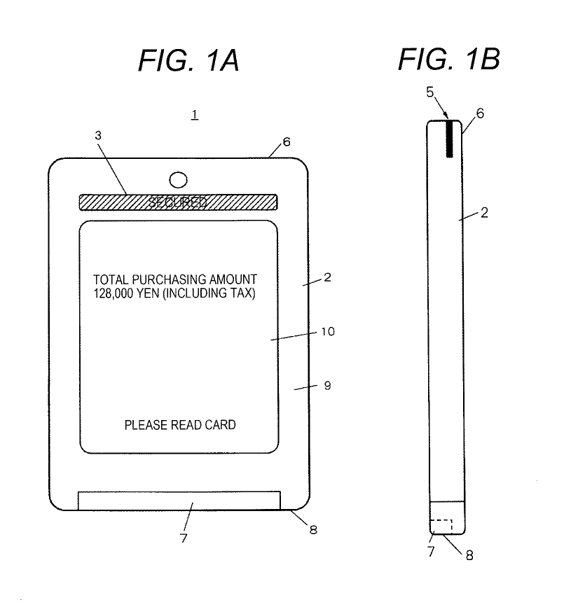

FIG. 1A is a front view illustrating the appearance of a payment terminal apparatus 1 according to a first embodiment. FIG. 1B is a side view illustrating the appearance of payment terminal apparatus 1 shown in FIG. 1A. Payment terminal apparatus 1 according to the embodiment is a portable apparatus, and includes, for example, an information processing unit 2 which performs various information processes including a payment process in the transaction of products or services.

In the description below, “secured” means that a payment terminal apparatus has tamper resistance which is necessary for a man-in-the-middle attack with regard to information from a third party (an ill-intentioned third party, virus, such as malware, or an unauthorized application), and “non-secure” means that the tamper resistance is not provided.

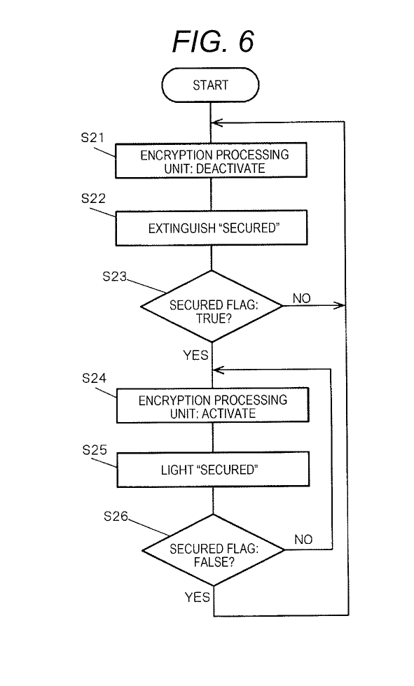

Payment terminal apparatus 1 shown in FIG. 1A includes a touch panel 10 which is arranged approximately at the center of front surface 9 of payment terminal apparatus 1, and LED display 3 which is arranged on the upper side of touch panel 10 and explicitly displays letters “SECURED” by lighting a Light Emitting Diode (LED) element. In FIG. 1A, the light of the LED element of LED display 3 is not on, and thus the letters “SECURED” are in a state which is not explicitly displayed. Meanwhile, a state in which the letters “SECURED” are explicitly displayed will be described with reference to a state shown in FIG. 6.

In addition, payment terminal apparatus 1 shown in FIG. 1A includes, for example, a slit 5, which is a magnetic card sliding passage used to read a card information recorded on a magnetic card, on the upper side surface 6 of information processing unit 2. Payment terminal apparatus 1 includes, for example, a slot 7, to which a contact type IC card is inserted in order to read card information recorded in a contact type IC card, on the bottom side surface 8 of information processing unit 2. Payment terminal apparatus 1 includes, for example, a loop antenna 38 inside payment terminal apparatus 1 used to read card information recorded in a non-contact type IC card.

### (Hardware Configuration Of Payment Terminal Apparatus)

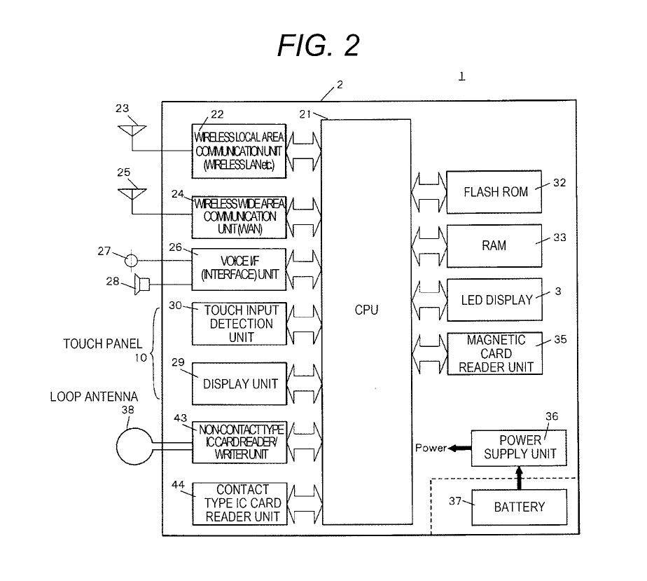

FIG. 2 is a block diagram illustrating an example of the hardware configuration of payment terminal apparatus 1 according to the embodiment. Payment terminal apparatus 1 shown in FIG. 2 includes CPU 21, wireless local area communication unit 22 to which wireless local area communication antenna 23 is connected, wireless wide area communication unit 24 to which wireless wide area communication antenna 25 is connected, voice I/F (Interface) unit 26 to which microphone 27 and speaker 28 are connected, display unit 29, touch input detection unit 30, flash ROM 32, RAM 33, LED display 3, magnetic card reader unit 35, power supply unit 36, battery 37, non-contact type IC card reader/writer unit 43 to which loop antenna 38 is connected, and contact type IC card reader unit 44.

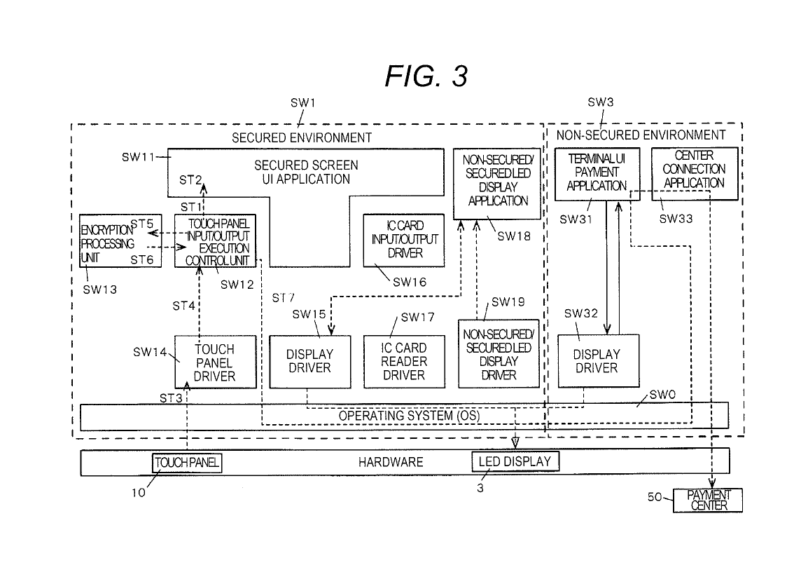

In addition, as shown in FIG. 3, payment terminal apparatus 1 provides, for example, a virtually secured execution environment and a virtually non-secured execution environment in Operating System (OS) SW0 which can be realized using CPU 21. Operating System (OS) SW0 provides, for example, the secured execution environment and the non-secured execution environment using, for example, a Virtual Machine (VM).

Information processing unit 2 of payment terminal apparatus 1 includes Central Processing Unit (CPU) 21 which entirely controls the processing in each of the units of payment terminal apparatus 1 shown in FIG. 2. In FIG. 2, each of the units of payment terminal apparatus 1 is connected to CPU 21.

Wireless local area communication unit 22 is connected to wireless local area communication antenna 23, and performs wireless communication using a wireless local area network, which is not shown in the drawing, for example, a wireless Local Area Network (LAN). The wireless local area communication is not limited to, for example, wireless LAN, and may be performed using a network other than Bluetooth (registered trademark).

Wireless wide area communication unit 24 is connected to wireless wide area communication antenna 25, and performs wireless wide area communication through a wireless Wide Area Network (WAN) which is not shown in the drawing. It is possible to perform wireless wide area communication using, for example, a mobile phone line such as a Wideband Code Division Multiple Access (W-CDMA), Universal Mobile Telecommunications System (UMTS), Code Division Multiple Access (CDMA) 2000, and Long Term Evolution (LTE).

Voice I/F unit 26, which is an example of a notification unit, is connected to microphone 27 and speaker 28, and controls the input and output of voice. Meanwhile, it is possible to make a call to another mobile phone or a fixed phone using microphone 27, speaker 28, voice I/F unit 26, and wireless wide area communication unit 24. In addition, speaker 28 may explicitly notify a user of a secured mode state or a non-secured mode state, which will be described later, according to an instruction from CPU 21, or may output an alarm sound for calling user's attention or an alarm sound for indicating operation errors when a user operates payment terminal apparatus 1.

Display unit 29 is formed using, for example, a Liquid Crystal Display (LCD) or an organic Electroluminescence (EL), and displays information or data, which is instructed to be displayed by CPU 21, on touch panel 10 shown in FIG. 1. Touch input detection unit 30 detects touch input of a user (for example, a clerk of a credit card affiliated store (for example, a store; hereinafter, referred to as “affiliated store”) which processes credit card transactions, or a customer who purchases a product) with regard to touch panel 10.

Flash Read Only Memory (ROM) 32 stores various data. The data to be stored may be, for example, data related to business, or a program used to control the operation of payment terminal apparatus 1 (mainly, information processing unit 2). In addition, the program includes various programs, such as an application (software) for a payment process, which pertain to the operation of payment terminal apparatus 1. Therefore, flash ROM 32 has a function as a recording medium which records the program.

Random Access Memory (RAM) 33 is a working memory which is used to temporally store processing data generated when an arithmetic operation in accordance with the operation of payment terminal apparatus 1 (mainly, information processing unit 2) is processed. In addition, a secured flag (for example, True or False) indicative of the presence/non-presence of a secured mode state which will be described later or a non-secured flag (for example, True or False) indicative of the presence/non-presence of the non-secured mode state is allocated to the specified area of RAM 33. Magnetic card reader unit 35 is arranged inside slit 5 shown in FIG. 1, and reads magnetic stripes as card information which is printed on a magnetic card. The card information, which is read by magnetic card reader unit 35, is input to CPU 21.

Non-contact type IC card reader/writer unit 43 is connected to loop antenna 38, and reads card information which is recorded in a non-contact type IC card. The card information, which is read by non-contact type IC card reader/writer unit 43, is input to CPU 21.

Contact type IC card reader unit 44 is arranged inside slot 7 shown in FIG. 1, and reads card information which is recorded in a contact type IC card through the electrodes of the contact type IC card which is inserted into slot 7. The card information, which is read by contact type IC card reader unit 44, is input to CPU 21.

LED display 3, which is an example of the notification unit, is a display which includes a plurality of LED elements, and lights or extinguishes the plurality of LED elements according to the instruction from CPU 21. For example, LED display 3 displays letters “SECURED” shown in FIG. 1A explicitly rather than letters “SECURED” shown in FIG. 6 by lighting the plurality of LED elements, and thus it is possible to easily notify the user of the secured mode state visually.

The power supply unit 36 is mainly the power source of information processing unit 2, receives the power supply accumulated in the battery 37, and supplies the power to each of the units of information processing unit 2 including CPU 21. The CPU 21 can perform or stop the supply power to a part of or all of the circuits, which form information processing unit 2, by controlling power supply unit 36. In addition to CPU 21, each of the units, that is, wireless local area communication unit 22, wireless wide area communication unit 24, display unit 29, touch input detection unit 30, non-contact type IC card reader/writer unit 43, contact type IC card reader unit 44, magnetic card reader unit 35, and LED display 3, is the power supply destination of power supply unit 36.

Payment terminal apparatus 1, which has the above configuration, has the features below.

In the embodiment, information processing unit 2 includes touch panel 10 (refer to FIGS. 1A, 1B, and 2) which includes display unit 29 and touch input detection unit 30, and wireless local area communication unit 22 or wireless wide area communication unit 24 which is capable of communicating with external connection-destination equipment (for example, payment center 50).

In recent years, a contact type IC card, a non-contact type IC card, or electronic money is added to a magnetic card which has been used for payment of transactions using an existing card, and the scheme of the payment of transactions using a card has been diversified. In accordance with the addition of the new scheme of payment, the development cost or price of payment terminal apparatus 1 has increased. Here, if information processing unit 2 is a consumer device, such as a smart phone or a tablet terminal, which is distributed, it is possible to lower the price of payment terminal apparatus 1, and thus the rise in development cost of payment terminal apparatus 1 is suppressed to the minimum.

In this case, in information processing unit 2, a general purpose OS (for example, refer to Operating System (OS) SW0 shown in FIG. 3) is used as a software platform. Accordingly, the development platform of an application for payment (payment application) and an application, which is used for other business (hereinafter, “business application”), is generalized, and thus it is easy to re-use or divert development assets. In addition, if it is possible to use the consumer device for the configuration of information processing unit 2, information processing unit 2 has high arithmetic capability to a possible degree without stress, and thus it is possible to cause the payment application and the business application to flexibly operate without stress.

### (Software Configuration Of Payment Terminal Apparatus)

FIG. 3 is a block diagram illustrating an example of a system configuration based on the software function of payment terminal apparatus 1 according to the embodiment in detail. In FIG. 3, each of the operations, which are executed in CPU 21 of information processing unit 2 of payment terminal apparatus 1, is shown as a software functional block. More specifically, each of the functions of Operating System (OS) SW0, secured screen UI application SW11, touch panel input/output execution control unit SW12, encryption processing unit SW13, touch panel driver SW14, display driver SW15, IC card input/output driver SW16, IC card reader driver SW17, non-secured/secured LED display application SW18, non-secured/secured LED display driver SW19, terminal UI payment application SW31, display driver SW32, and center connection application SW33 is executed (mounted) in CPU 21. Meanwhile, in FIG. 3, numerical symbols ST1 to ST7 show the procedure of a process related to PIN information which is input through touch panel 10 in the secured execution environment.

Payment terminal apparatus 1 according to the embodiment individually provides secured execution environment SW1 and non-secured execution environment SW3 to hardware HW0 of payment terminal apparatus 1 in Operating System (OS) SW0 using a virtualization application.

Secured execution environment SW1 is provided with secured screen UI application SW11, touch panel input/output execution control unit SW12, encryption processing unit SW13, touch panel driver SW14, display driver SW15, IC card input/output driver SW16, IC card reader driver SW17, non-secured/secured LED display application SW18, non-secured/secured LED display driver SW19, and Operating System (OS) SW0.

Operating System (OS) SW0, which is an example of a mode control unit, is basic software, which distinguishes and manages the secured mode state and the non-secured mode state of payment terminal apparatus 1 and which manages the secured execution environment and the non-secured execution environment. For example, Operating System (OS) SW0 is Windows (registered trademark) or Linux (registered trademark). Meanwhile, although description is performed such that Operating System (OS) SW0 distinguishes and manages each of the states of the secured mode and the non-secured mode in each embodiment, each of the states of the secured mode and the non-secured mode may be managed by touch panel input/output execution control unit SW12 similarly to each embodiment below.

Here, the secured mode is, for example, a state in which tamper resistance capable of securing the information security (confidentiality, completeness and usability) of input information input by touch panel 10 of payment terminal apparatus 1 is virtually applied as information or data which is processed by payment terminal apparatus 1. Accordingly, in the embodiment, a state in which the secured mode state is continued is shown by the secured flag. When the secured flag is “True”, the state is the secured mode state. When the secured flag is “False”, the state is the non-secured mode state.

In contrast, the non-secured mode is, for example, a state in which tamper resistance capable of securing the information security (confidentiality, completeness and usability) of input information input by touch panel 10 of payment terminal apparatus 1 is not virtually applied as the information or data which is processed by payment terminal apparatus 1. Accordingly, in a second embodiment, a state in which the non-secured mode state is continued is shown by the non-secured flag. When the non-secured flag is “True”, the state is the non-secured mode state. When the non-secured flag is “False”, the state is the secured mode state.

Touch panel driver SW14 controls the operation of touch panel 10, acquires certification information (for example, PIN information which is a password number) which is input by touch panel 10, and outputs the certification information to touch panel input/output execution control unit SW12.

Touch panel input/output execution control unit SW12 manages the input/output of the certification information, which is output from touch panel driver SW14, according to the secured flag or the non-secured flag which is output from the Operating System (OS) SW, and controls the execution of an operation related to the input/output of the PIN information. Touch panel input/output execution control unit SW12 activates or deactivates encryption processing unit SW13 according to the secured flag or the non-secured flag.

More specifically, touch panel input/output execution control unit SW12 deactivates encryption processing unit SW13 when the secured flag is “False” (non-secured flag is “True”), and activates encryption processing unit SW13 when the secured flag is “True” (non-secured flag is “False”).

Touch panel input/output execution control unit SW12 checks PIN information, which is output from touch panel driver SW14, and PIN information which is registered in an IC card. When it is determined that both pieces of PIN information coincide as a result of the checking, the PIN information is output to encryption processing unit SW13 and encryption processing unit SW13 is caused to encrypt the PIN information in the secured mode.

In contrast, even though touch panel input/output execution control unit SW12 determines that the PIN information, which is output from touch panel driver SW14, coincides with the PIN information which is registered in the IC card, the PIN information is not encrypted in the non-secured mode. In addition, touch panel input/output execution control unit SW12 instructs secured screen UI application SW11 to display a message for encouraging the user to input the PIN information.

Encryption processing unit SW13, which is an example of an encryption unit, holds an encryption key which can be decoded in payment center 50, encrypts the PIN information, which is output from touch panel input/output execution control unit SW12, using the encryption key, and outputs the encrypted PIN information to touch panel input/output execution control unit SW12. Meanwhile, an encryption process may include encryption based on a common key system, in which the same key as in payment center 50 is used, and encryption based on public key encryption system in which encryption processing unit SW13 and payment center 50 respectively hold their own private keys and hold the public keys of opposite parties.

Secured screen UI application SW11 displays a display screen, to which secured information is input, on touch panel 10 according to an instruction from touch panel input/output execution control unit SW12. More specifically, secured screen UI application SW11 displays the message for encouraging the user to input the PIN information, displays an asterisk (*) in a digit unit in order to hide the input PIN information or displays a message for providing notification that the payment process is stopped.

Display driver SW15 controls the operation of display unit 29 which forms touch panel 10, acquires, for example, letters or image data, which are output from touch panel input/output execution control unit SW12 or secured screen UI application SW11, and displays the acquired letters or image data on display unit 29.

IC card reader driver SW17 controls the operation of contact type IC card reader unit 44 or non-contact type IC card reader/writer unit 43, and transfers the read card information to IC card input/output driver SW16. IC card reader driver SW17 may be mounted as an independent individual card reader driver on the respective non-contact type IC card reader/writer unit 43 and contact type IC card reader unit 44.

IC card input/output driver SW16 outputs the card information, which is output from IC card reader driver SW17, to touch panel input/output execution control unit SW12.

Non-secured/secured LED display application SW18 sets the plurality of LED elements of LED display 3 to a lit (on) state or an extinguished (off) state according to the secured flag (refer to the embodiment) or the non-secured flag (refer to the second embodiment).

Non-secured/secured LED display driver SW19 controls the operation of LED display 3, and controls lighting or extinguishing of one or more LED elements of LED display 3 according to setting made by non-secured/secured LED display application SW18. The lighting or extinguishing of “SECURED” in LED display 3 is performed in such a way that non-secured/secured LED display application SW18 controls non-secured/secured LED display driver SW19 after receiving the instruction from touch panel input/output execution control unit SW12 under secured execution environment SW1.

For example, when the secured flag is “True”, non-secured/secured LED display driver SW19 lights LED display 3 (refer to FIG. 6) in order to explicitly notify the user of a state which is a secured mode. In contrast, when the secured flag is “False”, non-secured/secured LED display driver SW19 extinguishes LED display 3 (refer to FIG. 1A) in order to explicitly notify the user of a state which is a non-secured mode.

The important thing in the above-described configuration is that the control of the lighting or extinguishing of LED display 3, which performs non-secured or secured display, is performed under secured execution environment SW1. In the secured mode state, the fact that the state is a secured mode is explicitly shown to the user. Accordingly, even when the information processing apparatus includes a non-secured part, the user is less likely to confuse and can input information to touch panel 10 in the secured mode state without anxiety. In addition, the information processing apparatus can ensure tamper resistance for input information which is input to touch panel 10 through the input operation performed by the user.

Subsequently, non-secured execution environment SW3 is provided with terminal UI payment application SW31, display driver SW32, center connection application SW33, and Operating System (OS) SW0.

Terminal UI payment application SW31 displays a display screen to which the non-secured information is input on touch panel 10 according to an instruction from Operating System (OS) SW0. For example, terminal UI payment application SW31 displays various pieces of information (payment related information) in the payment process, and receives various input operations. Further, terminal UI payment application SW31 communicates with payment center 50 which is connected through center connection application SW33, acquires encrypted PIN information, which is generated by encryption processing unit SW13, or plaintext information (for example, payment price, payment method), which is not encrypted, from Operating System (OS) SW0, and transmits or receives the payment related information (encrypted PIN information, card information (for example, an IC card issuing company, a relevant brand, or a card number), and processing information for sales (for example, payment price or payment method) or the like), which includes the encrypted PIN information or the plaintext information, to or from payment center 50.

Display driver SW32 controls the operation of display unit 29 which forms touch panel 10, acquires the payment screen, letters, or image data which is output from, for example, touch panel input/output execution control unit SW12 or terminal UI payment application SW31, and displays the acquired payment screen, letters, or image data on display unit 29.

Center connection application SW33 instructs wireless local area communication unit 22 or wireless wide area communication unit 24 to transmit the data of the payment related information, which is output from terminal UI payment application SW31, to payment center 50 or the like, which is the connection-destination equipment.

Payment terminal apparatus 1 includes the software functional blocks as shown in FIG. 3, and is thereby capable of operating in such a way as to alternately switch between the secured mode, which independently operates in the secured execution environment, and the non-secured mode, which independently operates in the non-secured execution environment, according to, for example, the input operation performed by the user.

### (Procedure Of Operation Performed When Payment Terminal Apparatus 1 Performs Payment Process)

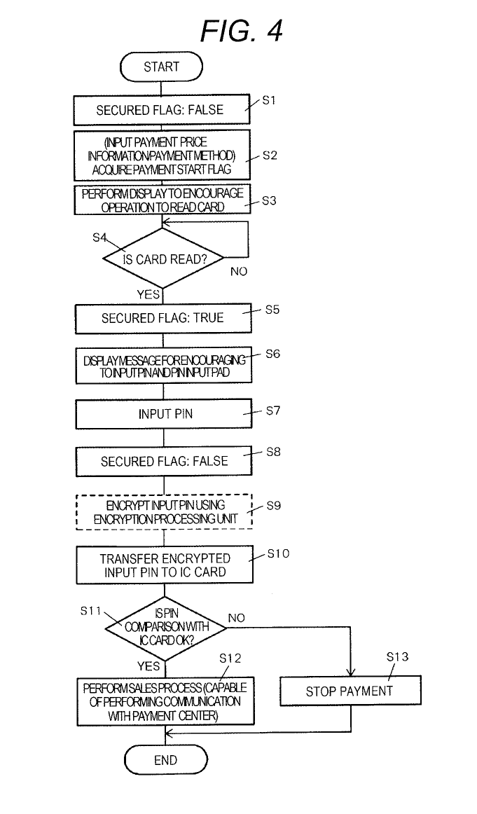

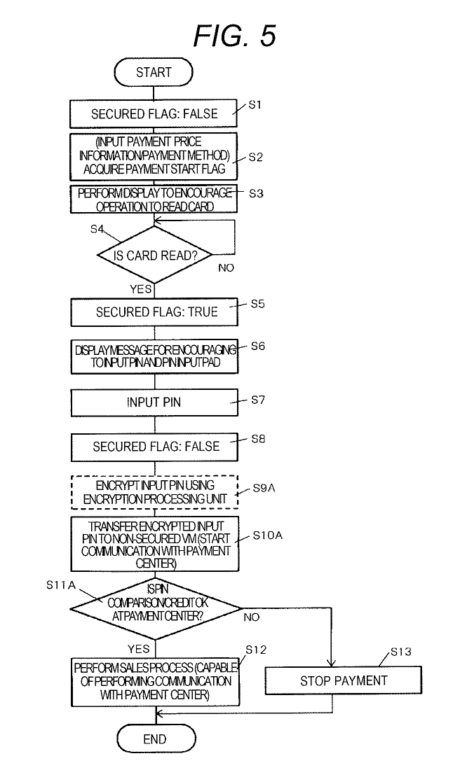

Subsequently, an operation performed when payment terminal apparatus 1 according to the embodiment performs the payment process will be described with reference to FIGS. 4 and 5. FIG. 4 is a flowchart illustrating the procedure of a first operation performed when payment terminal apparatus 1 according to the first embodiment performs a payment process in detail. FIG. 5 is a flowchart illustrating the procedure of a second operation performed when the payment terminal apparatus according to the first embodiment performs the payment process. Payment terminal apparatus 1 executes terminal UI payment application SW31 (refer to FIG. 3), which is installed in information processing unit 2 (refer to FIGS. 1 and 2), and starts the procedure of the payment process. Payment terminal apparatus 1 is in the non-secured mode state on the premise of the description with reference to FIGS. 4 and 5. In addition, in description with reference to FIG. 5, content which is different from that in description with reference to FIG. 4 will be described, and the same content will be simplified using the same step number or will not be repeated.

In FIG. 4 or 5, first, operating system SW0 sets the secured flag to “False” in order to indicate the non-secured mode state (S1). When the secured flag is set to “False”, an operation to extinguish LED display 3 is performed (refer to step S22 shown in FIG. 6).

When terminal UI payment application SW31 receives the payment price information and a payment method input (S2), terminal UI payment application SW31 displays a message for encouraging an operation to read a card on the screen (refer to FIG. 1A) of touch panel 10 (S3).

IC card input/output driver SW16 waits for the IC card to be read through any one of operations to slide the IC card into slit 5, to insert the IC card into slot 7, and to approach the IC card to front surface 9 of payment terminal apparatus 1 by the user (S4). When the IC card is read (S4, YES), operating system SW0 changes the secured flag to “True” in order to indicate that the state is changed to the secured mode state (S5). When the secured flag is changed to “True”, an operation to light LED display 3 is performed (refer to step S25 shown in FIG. 6).

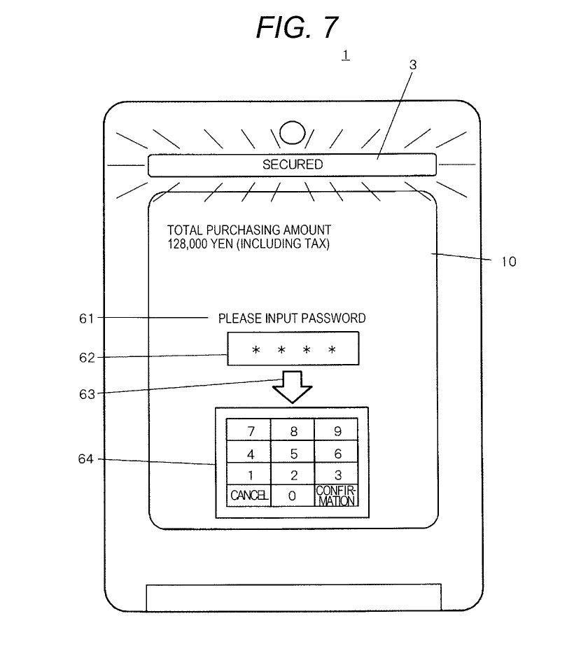

Secured screen UI application SW11 displays the message for encouraging the user to input the PIN information and an PIN pad 64 (refer to FIG. 7), which is an example of a software keyboard, on touch panel 10 (S6, refer to ST1 and ST2 of FIG. 3).

Touch panel input/output execution control unit SW12 inputs the PIN information, which is input using touch panel 10, through touch panel driver SW14 (S7, refer to ST3 of FIG. 4).

When the PIN information is input to touch panel input/output execution control unit SW12, the operating system SW0 changes the secured flag to “False” in order to indicate that the stat is changed to the non-secured mode state (S8). When the secured flag is changed to “False”, the operation to extinguish LED display 3 is performed (refer to step S22 shown in FIG. 6). An operation to light or extinguish “SECURED” in LED display 3A is performed in such a way that non-secured/secured LED display application SW18 receives the instruction from touch panel input/output execution control unit SW12 under secured execution environment SW1 and controls non-secured/secured LED display driver SW19.

In the procedure of the first operation performed when the payment process, in which it is necessary to refer to PIN and which is shown in FIG. 4, is performed, the PIN information, which is input in step S7, may be encrypted using a key which can be decoded using the IC card (not shown in the drawing) read in step S4 (S9). The PIN information, which is input using touch panel 10 in step S7, may be output to encryption processing unit SW13 and may be encrypted by encryption processing unit SW13. In addition, the encryption of the PIN information may be performed by an encryption processing unit (not shown in the drawing) which is separately provided from encryption processing unit SW13. Further, the PIN information (encrypted PIN information), which is encrypted by encryption processing unit SW13 or the encryption processing unit (not shown in the drawing), may be output to touch panel input/output execution control unit SW12.

Touch panel input/output execution control unit SW12 transfers the PIN information or the encrypted PIN information to the IC card through IC card input/output driver SW16 and IC card reader driver SW17 (S10).

With regard to the IC card, the PIN information, which is acquired by touch panel input/output execution control unit SW12, or data, which is acquired by decoding the encrypted PIN information, is compared with the PIN information which is registered in the IC card in advance, and a result of PIN comparison (S11). Touch panel input/output execution control unit SW12 inputs the result of PIN comparison, which is output from the IC card, through IC card reader driver SW17 and IC card input/output driver SW16.

If the result of comparison, in which the PIN information which is input in step S7 coincides with the PIN information which is read in step S4 and is registered in the IC card, is acquired from the IC card, touch panel input/output execution control unit SW12 instructs terminal UI payment application SW31 on non-secured execution environment SW3 to perform a sales process as a subsequent payment process through operating system SW0 (S12, refer to ST7 of FIG. 3).

If the result of comparison, in which the PIN information which is input in step S7 coincides with the PIN information which is read in step S4 and registered in the IC card, is acquired in non-secured execution environment SW3, terminal UI payment application SW31 performs the sales process as the subsequent payment process. Sales processing data acquired after the sales process is performed is transmitted to payment center 50 through center connection application SW33. Meanwhile, the sales process, which is performed on the sales processing data in step S12, may be performed whenever a customer purchases a product or receives a service. In addition, communication between payment terminal apparatus 1 and payment center 50 is performed at prescribed timing (for example, once a week), and the sales processing data may be collectively processed together with other sales processing data during the communication.

In contrast, when it is determined that both the pieces of PIN information do not coincide with each other as the result of PIN information comparison in step S11, touch panel input/output execution control unit SW12 causes secured screen UI application SW11 to display a message for causing touch panel 10 to stop the payment process (S13). Touch panel input/output execution control unit SW12 does not instruct terminal UI payment application SW31 to perform the sales process, and thus the procedure of a subsequent payment process stops.

In the procedure of the second operation performed when the payment process, in which it is necessary to refer to PIN and which is shown in FIG. 5, is performed, touch panel input/output execution control unit SW12 outputs the PIN information, which is input using touch panel 10 in step S7, to encryption processing unit SW13, and causes encryption processing unit SW13 to encrypt the PIN information.

Encryption processing unit SW13 encrypts the PIN information, which is output from touch panel input/output execution control unit SW12, using an encryption key which can be decoded in payment center 50 (or an acquirer, the same applies below), and outputs the encrypted PIN information to touch panel input/output execution control unit SW12 (S9A, refer to ST5 and ST6 of FIG. 3). Touch panel input/output execution control unit SW12 transfers the encrypted PIN information (encryption input PIN) to terminal UI payment application SW31 on non-secured execution environment SW3 (non-secured VM) through operating system SW0 (S10A, refer to ST7 of FIG. 3).

In non-secured execution environment SW3, terminal UI payment application SW31 communicates with payment center 50 through center connection application SW33, transmits the encrypted PIN information which is generated in step S9A, and performs inquiry of credit using the card information of the card which is read in step S4 (S11A).

Payment center 50 decodes the PIN information which is received from terminal UI payment application SW31 of payment terminal apparatus 1, and compares the PIN information, which is managed in payment center 50, with the decoded PIN information. When the two pieces of PIN information coincide with each other and it is recognized that a comparison target card does not have a problem for transaction (for example, the comparison target card is not on a blacklist) (S11A, YES), payment center 50 credits terminal UI payment application SW31 through center connection application SW33 of payment terminal apparatus 1.

Terminal UI payment application SW31 of payment terminal apparatus 1 receives the credit of payment center 50 in step S11A, performs the sales process as a subsequent payment process (S12), and ends the communication with payment center 50. Meanwhile, the sales process, which is performed on the sales processing data in step S12, may be performed whenever a customer purchases a product or receives a service. In addition, the communication between payment terminal apparatus 1 and payment center 50 is performed at prescribed timing (for example, once a week), and the sales processing data may be collectively processed together with other sales processing data during the communication.

In contrast, when a message for providing notification that the comparison of the encrypted PIN information or the credit comparison using the card information fails is replied from payment center 50 (S11A, NO), terminal UI payment application SW31 instructs to display a message for causing the payment process to stop. Touch panel input/output execution control unit SW12 causes secured screen UI application SW11 to display the message for causing touch panel 10 to stop the payment process (S13). Touch panel input/output execution control unit SW12 does not instruct terminal UI payment application SW31 to perform the sales process, and stops the procedure of a subsequent payment process.

Meanwhile, the encryption process, which is performed by encryption processing unit SW13 in step S9 of FIG. 4 or step S9A of FIG. 5, may be performed at a timing between step S7 and step S8.

Subsequently, the procedure of an operation to light or extinguish LED display 3 of payment terminal apparatus 1 according to the embodiment will be described with reference to FIG. 6. FIG. 6 is a flowchart illustrating the procedure of the operation to light or extinguish LED display 3. Payment terminal apparatus 1 is in the non-secured mode state on the premise of the description with reference to FIG. 6.

In FIG. 6, in a case of the non-secured mode state, touch panel input/output execution control unit SW12 deactivates encryption processing unit SW13 (S21), and instructs non-secured/secured LED display application SW18 to extinguish LED display 3. Non-secured/secured LED display application SW18 sets LED display 3 to an extinguished state according to the instruction from touch panel input/output execution control unit SW12, and instructs non-secured/secured LED display driver SW19 to extinguish LED display 3 (S22). Therefore, LED display 3 is extinguished, and the letters “SECURED” is not lit as shown in FIG. 1A.

Thereafter, operating system (OS) SW0 or touch panel input/output execution control unit SW12 determines whether or not the secured flag is changed to “True” (S23). Meanwhile, the change in the secured flag may be performed according to, for example, the input operation performed by the user through operating system (OS) SW0 or touch panel input/output execution control unit SW12, or may be performed at a prescribed timing (for example, timing at which the PIN information is input or timing at which the input of the PIN information is completed).

When the secured flag is “False” (S23, NO), touch panel input/output execution control unit SW12 continuously deactivates encryption processing unit SW13. Therefore, a state, in which LED display 3 is extinguished, is maintained.

In contrast, when the secured flag is changed to “True” (S23, YES), touch panel input/output execution control unit SW12 activates encryption processing unit SW13 (S24), and instructs non-secured/secured LED display application SW18 to light LED display 3. Non-secured/secured LED display application SW18 sets LED display 3 to a lit state according to the instruction from touch panel input/output execution control unit SW12, and instructs non-secured/secured LED display driver SW19 to light LED display 3 (S25). Therefore, LED display 3 is lit and the letters “SECURED” are lit as shown in FIG. 7.

Thereafter, operating system SW0 or touch panel input/output execution control unit SW12 determines whether or not the secured flag is “False” (S26). When the secured flag is “True” (S26, NO), operations in steps S24 to S26 are repeated. In contrast, when the secured flag is changed to “False” (S26, YES), the process returns to the operation subsequent to step S21.

Meanwhile, in the embodiment, the process of the lighting or extinguishing operation shown in FIG. 6 is repeatedly performed in a different routine from the process shown in FIG. 4 or FIG. 5. However, the process of the lighting or extinguishing operation shown in FIG. 6 may be performed based on the fact that the secured flag is set in step S1 of FIG. 4 or FIG. 5 or the secured flag is changed in steps S5 and S8.

FIG. 7 is a front view illustrating the appearance of payment terminal apparatus 1 in the secured mode. In a case of the secured mode state, LED display 3A, which includes a plurality of LED elements in order to light the letters “SECURED”, is lit.

As the message for encouraging input of the PIN information corresponding to step S6 shown in FIG. 4 or FIG. 5, letters 61 “please input password”, an input box 62 in which the input password (PIN) is displayed, an arrow mark 63, and a PIN pad 64, which is a software keyboard for inputting the password (PIN), are displayed on touch panel 10 shown in FIG. 7. In addition, when the PIN information is input in step S7 shown in FIG. 4 or FIG. 5, an asterisk (*) is displayed at every input in input box 62 which is displayed on touch panel 10.

What is important in the above-described configuration is that the lighting or extinguishing of LED display 3 which performs non-secured/secured display is controlled under secured execution environment SW1. In the secured mode state, the secured mode is explicitly shown to the user. Therefore, when payment terminal apparatus 1 (information processing apparatus) includes a non-secured part, the user is less likely to confuse and can input information to touch panel 10 in the secured mode state without anxiety. In addition, payment terminal apparatus 1 (information processing apparatus) can ensure tamper resistance for input information which is input to touch panel 10 through the input operation performed by the user.

As described above, payment terminal apparatus 1 according to the first embodiment clearly distinguishes and manages between the secured mode and the non-secured mode according to the “True” and “False” of the secured flag. In the secured mode state, it is possible to visually inform the user about the secured mode understandably. Further, since the PIN information, which is input using touch panel 10 is encrypted, it is possible to accurately ensure the security of the input PIN information without providing the touch panel with a special structure as in U.S. Pat. No. 8,376,219. Therefore, in payment terminal apparatus 1 according to the embodiment, certification information, such as PIN, is safely input by the user with fewer mistakes, and thus it is possible to ensure the tamper resistance for securing the security of the PIN information which is input using touch panel 10. Further, it is possible to safely perform the payment process using the information processing apparatus.

In addition, when the secured mode is changed to the non-secured mode, payment terminal apparatus 1 according to the embodiment stops providing notification (lighting of LED display 3) for indicating the secured mode, and thus it is possible to easily provide notification that the mode is changed to the non-secured mode to the user.

### Modification Example Of First Embodiment

A payment terminal apparatus 1A according to a modification example of the first embodiment does not have the configuration of LED display 3, and displays an image indicative of the secured mode state on touch panel 10 instead of LED display 3.

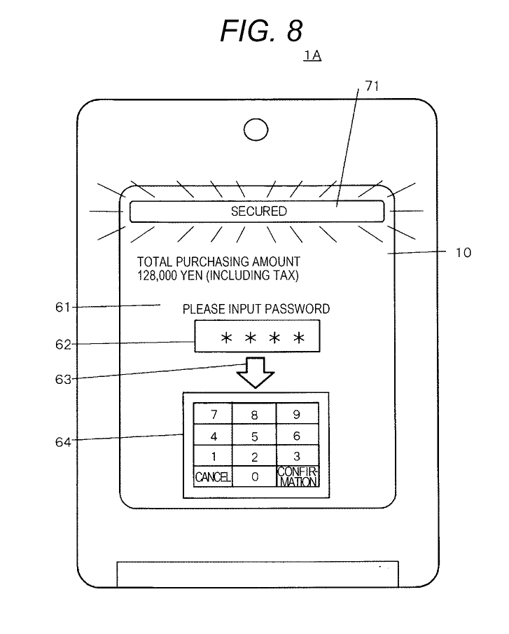

FIG. 8 is a front view illustrating the appearance of payment terminal apparatus 1A in the secured mode according to the modification example of the first embodiment. FIG. 8 is different from FIG. 7 in that, when the user inputs the PIN information, secured image 71, which includes letters “SECURED” indicative of the secured mode state, is displayed on touch panel 10 without indicating the secured mode state using LED display 3. The display/non-display of “SECURED” on touch panel 10 is performed in such a way that non-secured/secured LED display application SW18 receives the instruction from touch panel input/output execution control unit SW12 and controls display driver SW15 under secured execution environment SW1.

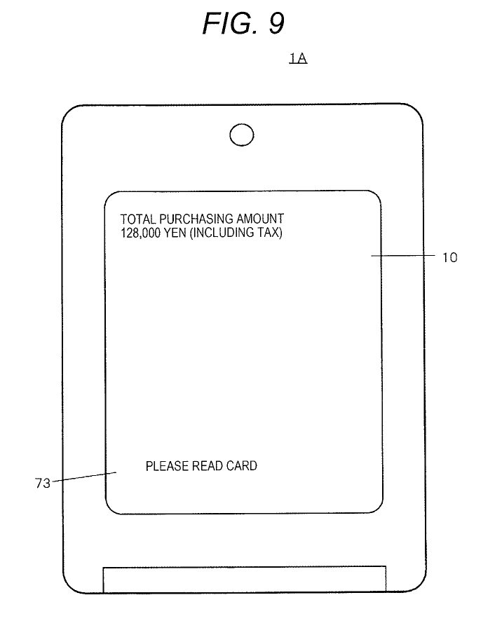

FIG. 9 is a front view illustrating the appearance of payment terminal apparatus 1A in the non-secured mode. In the non-secured mode state, secured image 71 is not displayed unlike FIG. 8, and letters 73 “please read card” is displayed when the user is encouraged to read an IC card, compared to FIG. 1A.

As above, in the modification example of the first embodiment, payment terminal apparatus 1A displays secured image 71 on touch panel 10, and thus it is possible to visually inform the user about the secured mode state understandably.

What is important in the above-described configuration is that the display of touch panel 10 which performs non-secured/secured display is controlled under secured execution environment SW1. In the secured mode state, the secured mode is explicitly shown to the user. Therefore, when payment terminal apparatus 1A (information processing apparatus) includes a non-secured part, the user is less likely to confuse and can input information to touch panel 10 in the secured mode state without anxiety. In addition, payment terminal apparatus 1A (information processing apparatus) can ensure tamper resistance for input information which is input to touch panel 10 through the input operation performed by the user.

### Second Embodiment

In the above-described first embodiment, payment terminal apparatus 1 visually informs about the secured mode state understandably by lighting the LED display which includes the plurality of LED elements in order to light the letters “SECURED” shown in FIG. 7.

In a second embodiment, a case in which payment terminal apparatus 1B visually informs the non-secured mode state understandably by lighting LED display 3A which includes a plurality of LED elements in order to light letters “NON-SECURED”.

In addition, since payment terminal apparatus 1B according to the second embodiment is approximately the same configuration as payment terminal apparatus 1 according to the first embodiment, the same reference numerals are used to indicate the same components as in payment terminal apparatus 1 according to the first embodiment, and thus description is simplified or omitted and only different content will be described.

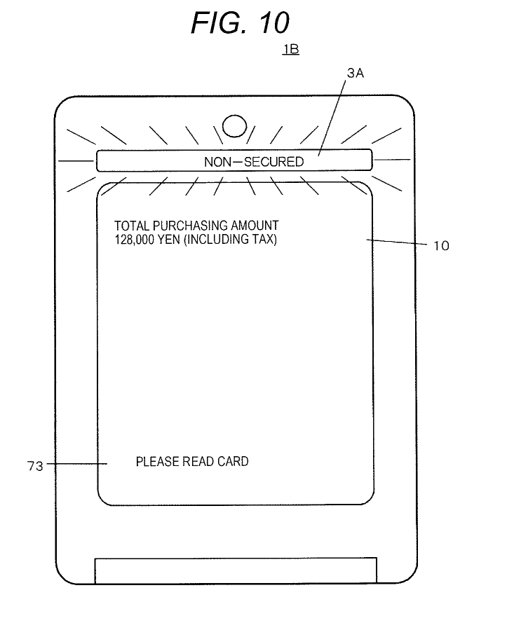

FIG. 10 is a front view illustrating the appearance of payment terminal apparatus 1B according to the second embodiment. In the second embodiment, LED display 3A is arranged on the upper side of front surface 9 of payment terminal apparatus 1B. When payment terminal apparatus 1B is in the non-secured mode. LED display 3A includes the plurality of LED elements in order to light the letters “NON-SECURED”. In addition, the above-described non-secured flag is assigned to RAM 33.

### (Operation Procedure When Payment Terminal Apparatus 1B Performs Payment Process)

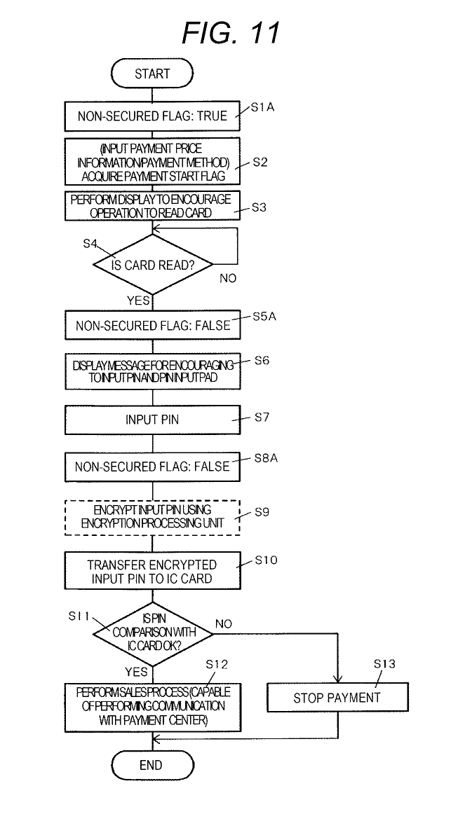

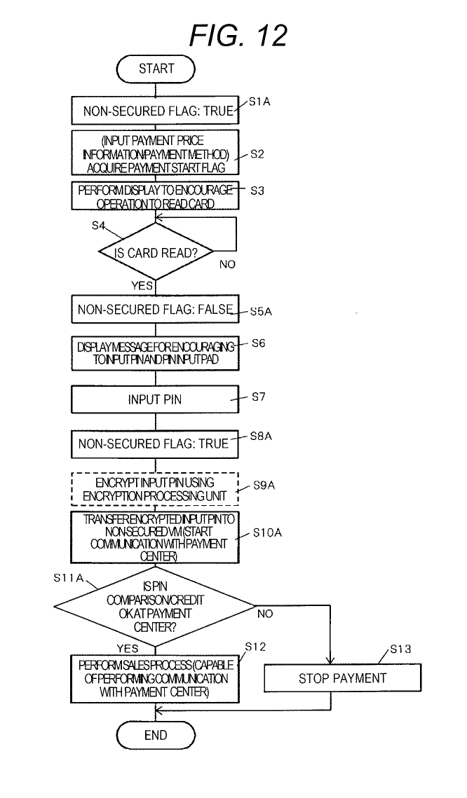

Subsequently, an operation when payment terminal apparatus 1B according to the embodiment performs a payment process will be described with reference to FIGS. 11 and 12. FIG. 11 is a flowchart illustrating the procedure of a first operation when payment terminal apparatus 1B according to the second embodiment performs the payment process. FIG. 12 is a flowchart illustrating the procedure of a second operation when payment terminal apparatus 1B according to the second embodiment performs the payment process. In description with reference to FIG. 11 or FIG. 12, the same step number is attached to the same content as in the description of the flowchart shown in FIG. 4 or FIG. 5 which correspond to payment terminal apparatus 1 according to the first embodiment, and thus description is simplified or omitted and only different content will be described. Payment terminal apparatus 1B is in the non-secured mode state on the premise of the description with reference to FIGS. 11 and 12.

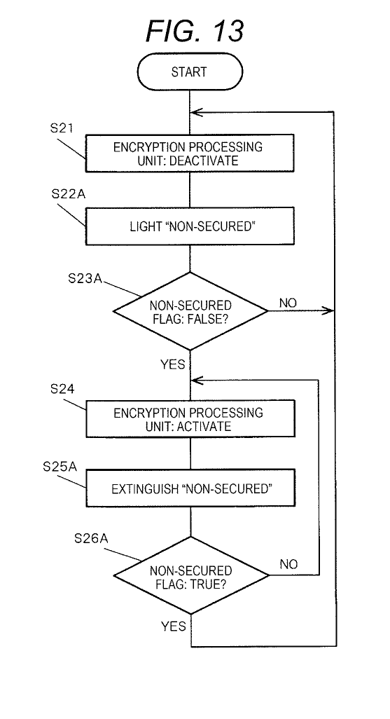

In FIGS. 11 and 12, first, operating system SW0 sets the non-secured flag to “True” in order to indicate the non-secured mode state (S1A). When the non-secured flag is set to “True”, an operation to light LED display 3A is performed (refer to step S22A shown in FIG. 13).

In addition, when an IC card is read in step S4 (S4, YES), operating system SW0 changes the non-secured flag to “False” in order to indicate that the state is changed to the secured mode state (S5A). When the non-secured flag is changed to “False”, an operation to extinguish LED display 3A is performed (refer to step S25A shown in FIG. 13).

In addition, when PIN information is input to touch panel input/output execution control unit SW12 in step S7, operating system SW0 changes the non-secured flag to “True” in order to indicate that the state is changed to the non-secured mode state (S8A). When the non-secured flag is changed to “True”, the operation to light LED display 3A is performed (refer to step S22A shown in FIG. 13). The lighting or extinguishing of “NON-SECURED” in LED display 3A is performed in such a way that non-secured/secured LED display application SW18 receives an instruction from touch panel input/output execution control unit SW12 under secured execution environment SW1, and controls non-secured/secured LED display driver SW19.

Subsequently, the procedure of the operation to light or extinguish LED display 3A in payment terminal apparatus 1B according to the embodiment will be described with reference to FIG. 13. FIG. 13 is a flowchart illustrating the procedure of the operation to light or extinguish LED display 3A. In the description of the flowchart shown in FIG. 13, the same step number is attached to the same content as in the description of the flowchart shown in FIG. 6 which corresponds to payment terminal apparatus 1 according to the first embodiment, and thus description is simplified or omitted and only different content will be described. Payment terminal apparatus 1B is in the non-secured mode state on the premise of the description with reference to FIG. 13.

In FIG. 13, in a case of the non-secured mode state, touch panel input/output execution control unit SW12 deactivates encryption processing unit SW13 (S21), and instructs non-secured/secured LED display application SW18 to light LED display 3A. Non-secured/secured LED display application SW18 makes setting such that LED display 3A is lit according to the instruction from touch panel input/output execution control unit SW12, and instructs non-secured/secured LED display driver SW19 to light LED display 3A (S22A). Therefore, LED display 3A is lit, and the letters “NON-SECURED” are lit as shown in FIG. 10.

Thereafter, operating system SW0 or touch panel input/output execution control unit SW12 determines whether or not the non-secured flag is changed to “False” (S23A). Meanwhile, the change in the non-secured flag may be performed according to, for example, an input operation performed by the user through operating System (OS) SW0 or touch panel input/output execution control unit SW12, or may be performed at prescribed timing (for example, timing in which the PIN information is input or timing in which the input of the PIN information is completed).

When the non-secured flag is “True” (S23A, NO), touch panel input/output execution control unit SW12 continues to deactivate encryption processing unit SW13. Therefore, a state in which LED display 3A is lit is maintained.

In contrast, when the non-secured flag is changed to “False” (S23A, YES), touch panel input/output execution control unit SW12 activates encryption processing unit SW13 (S24), and instructs non-secured/secured LED display application SW18 to extinguish LED display 3A. Non-secured/secured LED display application SW18 makes setting such that LED display 3A is extinguished according to the instruction from touch panel input/output execution control unit SW12, and instructs non-secured/secured LED display driver SW19 to extinguish LED display 3A (S25A).

Thereafter, operating system SW0 or touch panel input/output execution control unit SW12 determines whether or not the non-secured flag is “True” (S26A). When the non-secured flag is “False” (S26A, NO), the operations in steps S24 to S26A are repeated. In contrast, when the non-secured flag is changed to “True” (S26A, YES), the process returns to operations subsequent to step S21.

Meanwhile, in the embodiment, the process of the lighting or extinguishing operation shown in FIG. 13 is repeatedly performed in a different routine from the process shown in FIG. 11. However, the process of the lighting or extinguishing operation shown in FIG. 13 may be performed based on the fact that the non-secured flag is set in step S1A of FIG. 11 or the non-secured flag is changed in steps S5A and SBA.

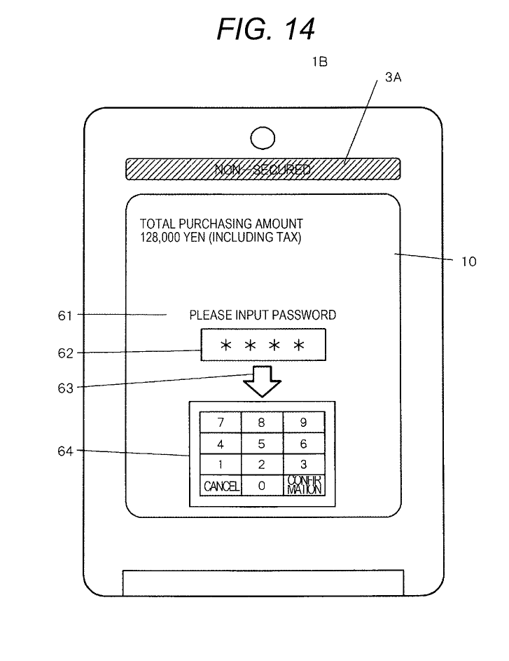

FIG. 14 is a front view illustrating the appearance of payment terminal apparatus 1B in the secured mode. In a case of the secured mode state, LED display 3A, which includes the plurality of LED elements in order to light the letters “NON-SECURED”, is extinguished.

As a message for encouraging input of the PIN information corresponding to step S6 shown in FIG. 11, letters 61 “please input password”, input box 62 in which the input password (PIN) is displayed, an arrow mark 63, and a PIN pad 64, which is a software keyboard for inputting the password (PIN), are displayed on touch panel 10 shown in FIG. 14. In addition, when the PIN information is input in step S7 shown in FIG. 11, an asterisk (*) is displayed at every input in input box 62 which is displayed on touch panel 10.

What is important in the above-described configuration is that the lighting or extinguishing of LED display 3 which performs non-secured/secured display is controlled under secured execution environment SW1. In the non-secured mode state, the non-secured mode is explicitly shown to the user. Therefore, when payment terminal apparatus 1B (information processing apparatus) includes a non-secured part, the user is less likely to confuse and can input information to touch panel 10 in the secured mode state without anxiety. In addition, payment terminal apparatus 1B (information processing apparatus) can ensure tamper resistance for input information which is input to touch panel 10 through the input operation performed by the user.

As described above, payment terminal apparatus 1B according to the second embodiment clearly distinguishes and manages between the non-secured mode and the secured mode according to the “True” and “False” of the non-secured flag. In the non-secured mode state, it is possible to visually inform the user about the non-secured mode understandably. Further, the PIN information, which is input using touch panel 10 is not encrypted, and the PIN information is encrypted in a case of the secured mode state. Therefore, in payment terminal apparatus 1B can perform control such that the complication of the structure of the touch panel to be minimized, and can ensure the tamper resistance for securing the security of the PIN information which is input using touch panel 10.

In addition, when the non-secured mode is changed to the secured mode, payment terminal apparatus 1B according to the embodiment stops providing notification indicative of the non-secured mode (lighting of LED display 3A), and thus it is possible to easily provide notification that the state is changed to the secured mode to the user.

### Modification Example Of Second Embodiment

Payment terminal apparatus 1C according to a modification example of the second embodiment does not include the configuration of LED display 3A, and displays an image indicative of the non-secured mode state on touch panel 10 instead of LED display 3A.

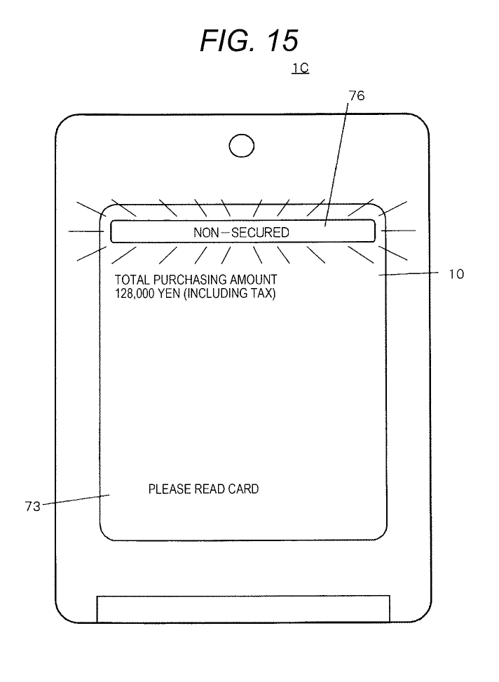

FIG. 15 is a front view illustrating the appearance of payment terminal apparatus 1C in the non-secured mode according to the modification example of the second embodiment. FIG. 10 is different from FIG. 15 in that, when payment terminal apparatus 1C displays a message for encouraging the user to read the IC card, the non-secured mode state is not displayed using LED display 3A, and a non-secured image 76, which includes letters “NON-SECURED” indicative of the non-secured mode state, is displayed on touch panel 10. The display/non-display of “NON-SECURED” on touch panel 10 is performed in such a way that non-secured/secured LED display application SW18 receives an instruction from touch panel input/output execution control unit SW12 under secured execution environment SW1, and controls display driver SW15.

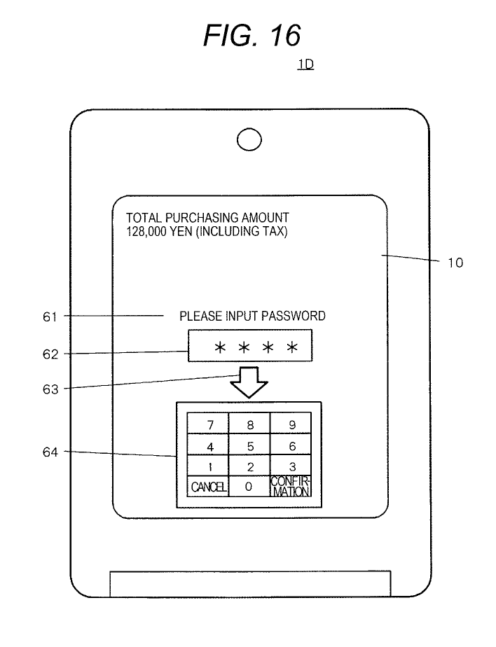

FIG. 16 is a front view illustrating the appearance of payment terminal apparatus 1C in the secured mode. In the secured mode state, non-secured image 76 is not displayed when the PIN information is input.

As above, in the modification example of the second embodiment, payment terminal apparatus 1C can visually show the non-secured mode state to the user understandably by displaying non-secured image 76 on touch panel 10.

What is important in the above-described configuration is that the display of touch panel 10 which performs non-secured/secured display is controlled under secured execution environment SW1. In the non-secured mode state, the non-secured mode is explicitly shown to the user. Therefore, when payment terminal apparatus 1C (information processing apparatus) includes a non-secured part, the user is less likely to confuse and can input information to touch panel 10 in the secured mode state without anxiety. In addition, payment terminal apparatus 1C (information processing apparatus) can ensure tamper resistance for input information which is input to touch panel 10 through the input operation performed by the user.

Hereinbefore, various embodiments are described with reference to the accompanying drawings. However, it is apparent that the present disclosure is not limited to the examples. Further, it is clear that those skilled in the art may think of various changes and modifications without departing from the gist disclosed in claims, and it is understood that the changes and modifications are included in the technical scope of the present disclosure.

For example, in the embodiment, the secured environment and the non-secured environment are realized by combining a host OS and a virtualization application. However, the secured execution environment and the non-secured execution environment may be realized using a virtualization hypervisor (virtualization machine monitor).

It is possible to apply the present disclosure to an apparatus which requires various secured inputs, such as an ATM in a bank, in addition to the payment terminal apparatus.

What is claimed is:

1. A payment terminal apparatus comprising:
an information processing unit that includes a display unit which is accommodated in a housing and is configured to display price or the like relevant to payment in a first non-secured execution environment, and an input unit to which certification information for identity verification is input in a second secured execution environment;
a notification unit that provides notification about a secured mode state; and
a notification control unit that is provided in the second secured execution environment and is configured to control the notification unit,
wherein the notification control unit does not provide the notification about the secured mode state to the notification unit when a payment process starts, and subsequently provides the notification about the secured mode state to the notification unit until at least the certification information is input to the input unit.

2. The payment terminal apparatus of claim 1,
wherein the notification unit provides the notification about the secured mode state by lighting an LED or performing screen display.

3. The payment terminal apparatus of claim 1,
wherein the notification control unit ends the provision of the notification about the secured mode state when the secured mode state is changed to a non-secured mode state.

4. The payment terminal apparatus of claim 3,
wherein the notification unit provides the notification about the secured mode state by lighting an LED or performing screen display.

5. A payment terminal apparatus comprising:
an information processing unit that includes a display unit which is accommodated in a housing and is configured to display price or the like relevant to payment in a first non-secured execution environment, and an input unit to which certification information for identity verification is input in a second secured execution environment;
a notification unit that provides notification about a non-secured mode state; and
a notification control unit that is provided in the second secured execution environment and is configured to control the notification unit,
wherein the notification control unit provides the notification about the non-secured mode state to the notification unit when a payment process starts, and subsequently ends the provision of the notification about the non-secured mode state to the notification unit until at least the certification information is input to the input unit.

6. The payment terminal apparatus of claim 5,
wherein the notification unit provides the notification about the non-secured mode state by lighting an LED or performing screen display.

7. The payment terminal apparatus of claim 5,
wherein the notification control unit starts the provision of the notification about the non-secured mode state when the secured mode state is changed to the non-secured mode state.

8. The payment terminal apparatus according to claim 7,
wherein the notification unit provides the notification about the non-secured mode state by lighting an LED or performing screen display.
